(19) United States
(12) Patent Application Publication
(10) Pub. No.: US 2015/0262757 A1
(43) Pub. Date: Sep. 17, 2015

(54) MEMS DEVICE

(71) Applicant: KABUSHIKI KAISHA TOSHIBA, Tokyo (JP)

(72) Inventor: Hiroaki YAMAZAKI, Yokohama Kanagawa (JP)

(73) Assignee: KABUSHIKI KAISHA TOSHIBA, Tokyo (JP)

(21) Appl. No.: 14/481,565

(22) Filed: Sep. 9, 2014

(30) Foreign Application Priority Data
Mar. 12, 2014 (JP) 2014-048858

(51) Int. Cl. H01G 5/16

(52) U.S. Cl. CPC H01G 5/16

(57) ABSTRACT

According to one embodiment, a MEMS device includes a lower electrode, a movable upper electrode having a portion facing the lower electrode, and a first member connected to the upper electrode. At least a part of a connecting portion of the upper electrode and the first member does not overlap the lower electrode when viewed from a direction vertical to a main surface of the lower electrode.

### CROSS-REFERENCE TO RELATED APPLICATIONS

This application is based upon and claims the benefit of priority from Japanese Patent Application No. 2014-048858, filed Mar. 12, 2014, the entire contents of which are incorporated herein by reference.

### FIELD

Embodiments described herein relate generally to a micro-electromechanical system (MEMS) device.

### BACKGROUND

A variable capacitor using MEMS technology is suggested. In this variable capacitor, change in the distance between the lower electrode (fixed electrode) and the upper electrode (movable electrode) varies capacitance. One end of an elastic insulating member (spring) is connected to the upper electrode. The other end of the insulating member is fixed to an anchor.

In the above-described variable capacitor, the upper electrode is easily deformed downward (in the substrate direction) in the portion connecting the upper electrode and the insulating member. Because of this, when the upper electrode approaches the lower electrode, the deformed portion of the upper electrode makes contact with the lower electrode, thereby restricting the distance between the upper electrode and the lower electrode in the deformed portion. This results in variation in capacitance and causes a problem in realizing a high-precision variable capacitor.

### BRIEF DESCRIPTION OF THE DRAWINGS

FIG. 1 schematically shows a basic structural example of a MEMS device according to an embodiment.

FIG. 2 shows measurement results of degree of deformation of an upper electrode.

FIG. 3 is a plan view schematically showing a specific structural example of the MEMS device according to the embodiment.

FIG. 4 is a cross-sectional view along line A-A′ of FIG. 3.

FIG. 5 is a cross-sectional view along line B-B′ of FIG. 3.

FIG. 6 is a cross-sectional view along line C-C′ of FIG. 3.

FIG. 7 is a plan view in which some structures are excluded from the structures shown in FIG. 3.

### DETAILED DESCRIPTION

In general, according to one embodiment, a MEMS device includes: a lower electrode; a movable upper electrode having a portion facing the lower electrode; and a first member connected to the upper electrode. At least a part of a connecting portion of the upper electrode and the first member does not overlap the lower electrode when viewed from a direction vertical to a main surface of the lower electrode.

Embodiments will be described hereinafter with reference to the accompanying drawings.

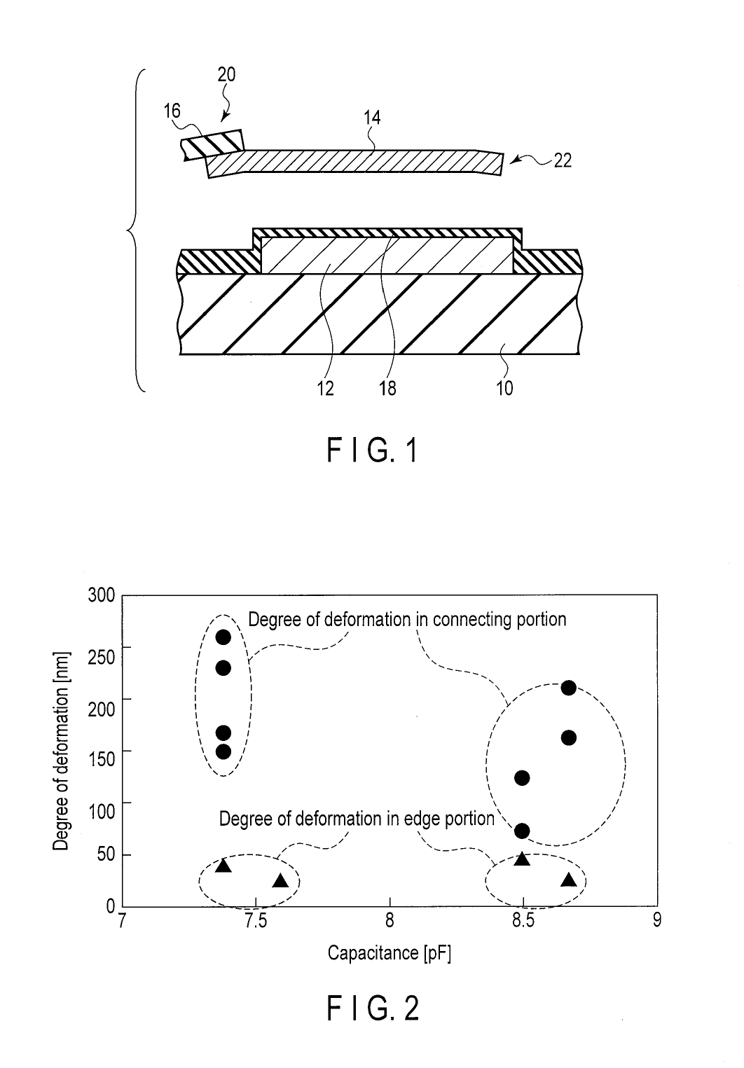

First, this specification explains a basic (conceptual) structural example of a MEMS device according to an embodiment. FIG. 1 schematically shows the basic structure of the MEMS device according to the embodiment.

The MEMS device shown in FIG. 1 comprises a lower electrode 12 fixed to an underlying area 10, a movable upper electrode 14 having a portion facing the lower electrode 12, and an insulating member (first member) 16 connected to the upper electrode 14. The underlying area 10 includes a transistor and interconnects, etc. Space is defined between the lower electrode 12 and the upper electrode 14. On the underlying area 10 and the lower electrode 12, an insulating film 18 is formed. The insulating film 18 is not limited to a single layer and may be formed of a plurality of layers.

A variable capacitor is composed of the lower electrode 12 and the upper electrode 14. Change in the distance between the lower electrode 12 and the upper electrode 14 varies the capacitance of the variable capacitor. Specifically, the insulating member 16 is elastic, and the upper electrode 14 connected to the insulating member 16 can be moved by an electrostatic force applied between the lower electrode 12 and the upper electrode 14.

The insulating member 16 is formed of silicon nitride. However, the material of the insulating member 16 is not limited to silicon nitride. The upper electrode 14 and the lower electrode 12 are formed of aluminum. However, the material of the upper electrode 14 or the lower electrode 12 is not limited to aluminum.

At least a part of a connecting portion 20 of the upper electrode 14 and the insulating member 16 does not overlap the lower electrode 12 when viewed vertically to the main surface of the lower electrode 12. Specifically, at least a part of the connecting portion 20 is located outside the area in which the lower electrode 12 is provided, or is located between areas in which the lower electrode 12 is provided. In the structure shown in FIG. 1, the whole of the connecting portion 20 does not overlap the lower electrode 12. At least a part of the edge of the upper electrode 14 overlaps the lower electrode 12 when viewed vertically to the main surface of the lower electrode 12.

As shown in FIG. 1, the upper electrode 14 is deformed downward (in the direction of the underlying area 10) in the connecting portion 20. The upper electrode 14 is also deformed downward in an edge portion 22 of the upper electrode 14. This deformation of the upper electrode 14 is caused due to the following factors.

When the variable capacitor is manufactured by means of the MEMS technology, a sacrificial film is formed around the variable capacitor first. Removal of the sacrificial film creates space between the lower electrode 12 and the upper electrode 14. The sacrificial film is formed by curing after application of a sacrificial film material. Since the sacrificial film material shrinks during the curing, a force is applied to the connecting portion 20 of the upper electrode 14 and the vicinity of the edge portion 22 of the upper electrode 14, thereby deforming the upper electrode 14. In particular, in the connecting portion 20, as the insulating member 16 is provided on the upper electrode 14, the degree of deformation is large.

FIG. 2 shows measurement results of degree of deformation of the upper electrode 14. The vertical axis represents degree of deformation; the horizontal axis, capacitance (maximum capacitance) of the variable capacitor when the upper electrode 14 is closest to the lower electrode 12. As shown in FIG. 2, the degree of deformation in the connecting portion 20 is greater than that in the edge portion 22.

In the case where the connecting portion 20 overlaps the lower electrode 12, the deformed portion (connecting portion 20) of the upper electrode makes contact with the lower electrode 12 when the upper electrode 14 approaches the lower electrode 12. This restricts the distance between the upper electrode 14 and the lower electrode 12 in the deformed portion, and causes variation in capacitance.

In this embodiment, as the connecting portion 20 does not overlap the lower electrode 12, the above-described problem can be avoided. As shown in FIG. 1, the upper surface of the lower electrode 12 is higher than the upper surface of the area around the lower electrode 12. Because of this structure, as long as the connecting portion 20 does not overlap the lower electrode 12, it is possible to prevent the deformed portion (connecting portion 20) from making contact with the lower electrode 12 or the area around the lower electrode 12 when the upper electrode 14 approaches the lower electrode 12. Thus, a detrimental effect on the precision of the capacitor due to the contact can be prevented.

In order to certainly prevent the contact of the deformed portion (connecting portion 20), as shown in FIG. 1, the entire connecting portion 20 should preferably not overlap the lower electrode 12. However, in the case where the degree of deformation increases towards the external side of the upper electrode 14 as shown in FIG. 1, the above-described problem can be avoided to some extent even in a structure in which a part of the connecting portion 20 does not overlap the lower electrode 12.

In terms of avoidance of contact of the deformed portion of the upper electrode 14, the edge portion 22 of the upper electrode 14 should preferably not overlap the lower electrode 12. However, if the edge portion 22 does not overlap the lower electrode 12, the occupation area of the variable capacitor is large. Further, as already indicated, the degree of deformation of the edge portion 22 is less than that of the connecting portion 20. In consideration of these factors, in this embodiment, the edge portion 22 of the upper electrode 14 is configured to overlap the lower electrode 12.

As described above, in this embodiment, at least a part of the connecting portion 20 of the upper electrode 14 and the insulating member 16 does not overlap the lower electrode 12. This structure prevents the deformed portion (connecting portion 20) from making contact with the lower electrode 12 or the area around the lower electrode 12 when the upper electrode 14 approaches the lower electrode 12. Thus, a detrimental effect on the precision of the capacitor can be prevented. Therefore, it is possible to inhibit variation in capacitance and realize a high-precision variable capacitor.

At least a part of the edge of the upper electrode 14 overlaps the lower electrode 12. Therefore, increase in the occupation area of the variable capacitor can be also inhibited.

Next, this specification explains a specific structural example of the MEMS device according to the embodiment.

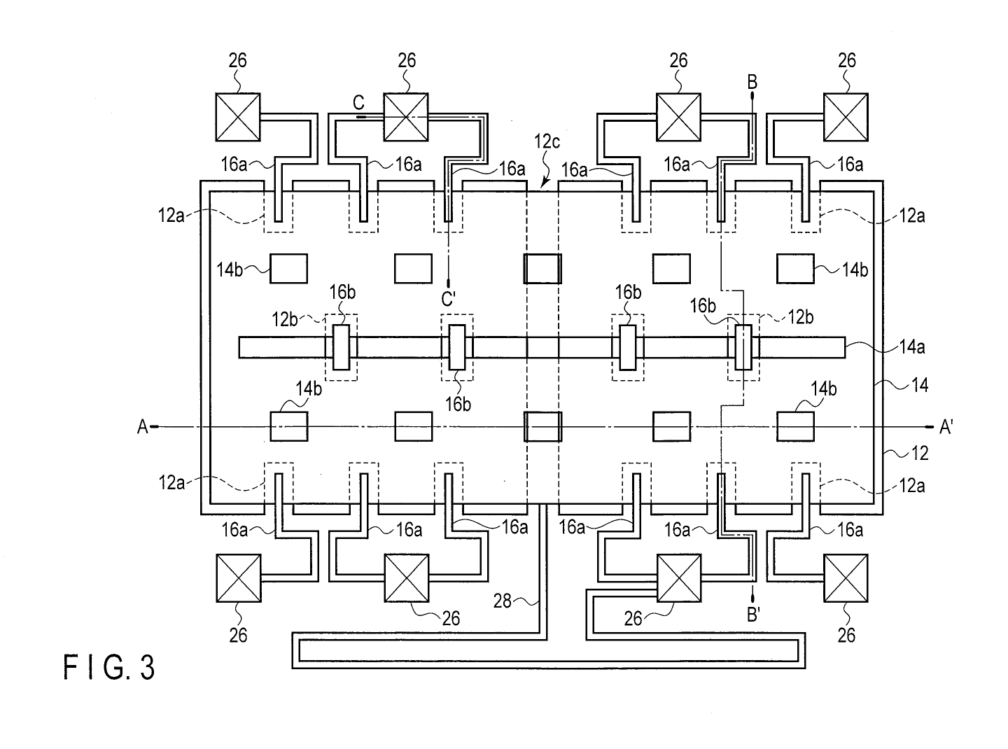

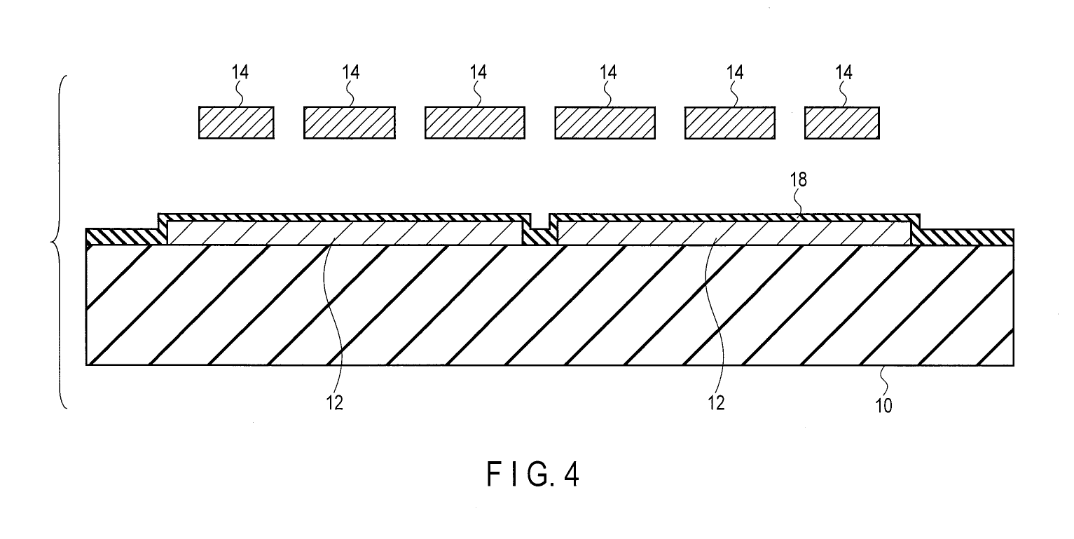

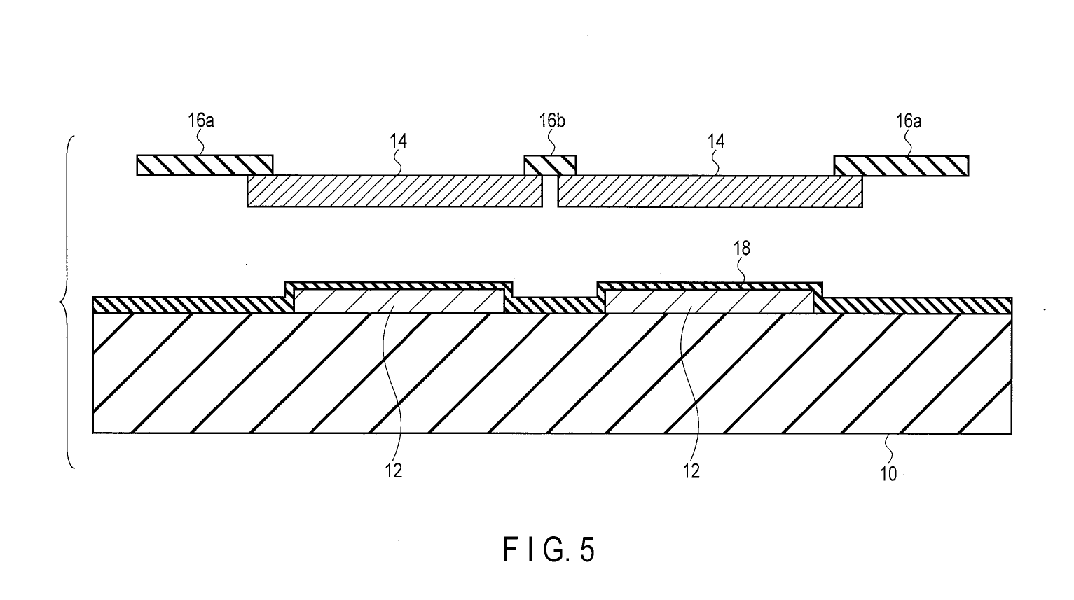

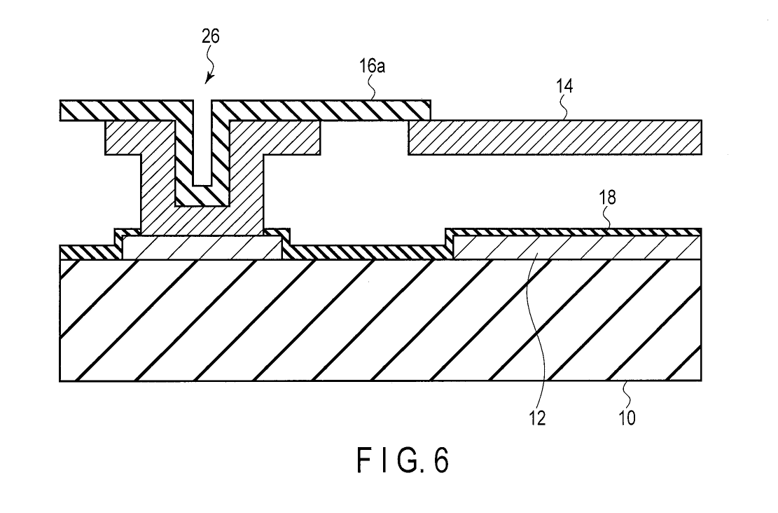

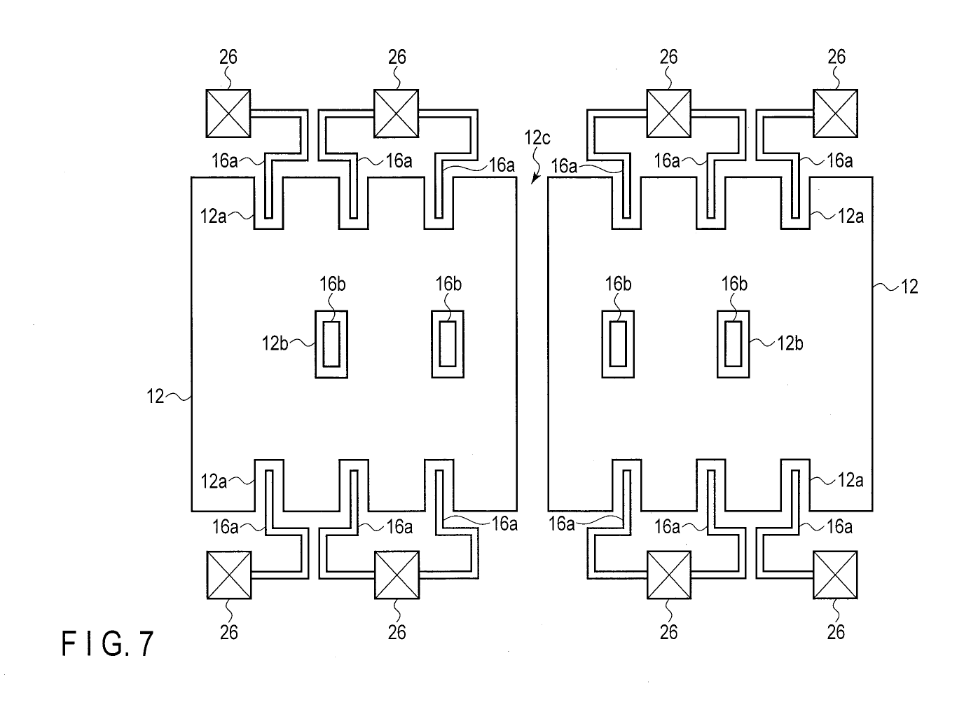

FIG. 3 is a plan view schematically showing the specific structure of the MEMS device according to the embodiment. FIG. 4 is a cross-sectional view along line A-A′ of FIG. 3. FIG. 5 is a cross-sectional view along line B-B′ of FIG. 3. FIG. 6 is a cross-sectional view along line C-C′ of FIG. 3. In FIG. 7, the upper electrode and the like are excluded from the plan view shown in FIG. 3.

The basic idea is the same as the idea explained in the above basic structural example. Therefore, explanations of matters which have been already described are omitted.

As shown in the figures, the lower electrode 12 comprises a recess pattern 12a, a hole pattern 12b and a space pattern 12c. The upper electrode 14 comprises a slit-like hole pattern 14a and a rectangular hole pattern 14b.

Insulating member (first member) 16a and insulating member (first member) 16b are connected to the upper electrode 14. A bias line 28 for applying a bias voltage to the upper electrode 14 is connected to the upper electrode 14.

Insulating member 16a is a supporting member configured to support the upper electrode 14. One end of the supporting member 16a is connected to the upper electrode 14. The other end of the supporting member 16a is fixed to an anchor 26. As the supporting member (insulating member) 16a is elastic, the supporting member 16a functions as a spring. The portion connecting the supporting member 16a and the upper electrode 14 is deformed downward (in the direction of the underlying area 10) although this structure is not shown in the figures.

The portion connecting the supporting member 16a and the upper electrode 14 is located at a position corresponding to the recess pattern 12a formed in the lower electrode 12. As shown in the figures, the portion connecting the supporting member 16a and the upper electrode 14 does not overlap the lower electrode 12.

Insulating member 16b is a bridge member configured to cross the slit-like hole pattern 14a formed in the upper electrode 14. Both ends of the bridge member 16a are connected to the upper electrode 14. Since the slit-like hole pattern 14a is formed in the upper electrode 14, the upper electrode 14 is reinforced with the bridge member 16b. The portion connecting the bridge member 16b and the upper electrode 14 is deformed downward (in the direction of the underlying area 10).

The portion connecting the bridge member 16b and the upper electrode 14 is located at a position corresponding to the hole pattern 12b formed in the lower electrode 12. As shown in the figures, the portion connecting the bridge member 16b and the upper electrode 14 does not overlap the lower electrode 12.

The edge of the upper electrode 14 overlaps the lower electrode 12 except for the area in which the recess pattern 12a, the hole pattern 12b and the space pattern 12c of the lower electrode 12 are provided.

As described above, the specific structural examples shown in FIG. 3 to FIG. 7 are the same as the basic structural example shown in FIG. 1 in terms of the basic positional relationships among the lower electrode 12, the upper electrode 14, the insulating members (the supporting member 16a and the bridge member 16b) and the portion connecting the upper electrode 14 and the insulating member. Therefore, an effect which is similar to that of the basic structural example can be obtained from the specific examples shown in FIG. 3 to FIG. 7.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A MEMS device comprising:
a lower electrode;
a movable upper electrode having a portion facing the lower electrode; and
a first member connected to the upper electrode, wherein
at least a part of a connecting portion of the upper electrode and the first member does not overlap the lower electrode when viewed from a direction vertical to a main surface of the lower electrode.

2. The device of claim 1, wherein
the whole of the connecting portion does not overlap the lower electrode when viewed from the direction vertical to the main surface of the lower electrode.

3. The device of claim 1, wherein
at least a part of an edge of the upper electrode overlaps the lower electrode when viewed from the direction vertical to the main surface of the lower electrode.

4. The device of claim 1, wherein
the first member is an insulating member.

5. The device of claim 1, wherein
the first member is elastic.

6. The device of claim 1, wherein
the first member is a supporting member configured to support the upper electrode.

7. The device of claim 6, wherein
one end of the supporting member is connected to the upper electrode, and the other end of the supporting member is fixed to an anchor.

8. The device of claim 1, wherein
the upper electrode has a slit-like hole pattern, and
the first member is a bridge member configured to cross the slit-like hole pattern.

9. The device of claim 8, wherein
both ends of the bridge member are connected to the upper electrode.

10. The device of claim 1, wherein
the lower electrode has a recess pattern, and the connecting portion is located at a position corresponding to the recess pattern.

11. The device of claim 1, wherein
the lower electrode has a hole pattern, and the connecting portion is located at a position corresponding to the hole pattern.

12. The device of claim 1, wherein
an upper surface of the lower electrode is located higher than an upper surface of an area around the lower electrode.

13. The device of claim 1, wherein
the upper electrode is deformed at the connecting portion.

14. The device of claim 1, wherein
the upper electrode is deformed at an edge of the upper electrode.

15. The device of claim 1, further comprising
an insulating film formed on the lower electrode.

16. The device of claim 1, wherein
the first member is formed of silicon nitride.

17. The device of claim 1, wherein
the upper electrode is formed of aluminum.

18. The device of claim 1, wherein
the lower electrode and the upper electrode constitute a variable capacitor.
